(19) United States
(12) Patent Application Publication
(10) Pub. No.: US 2006/0012357 A1
(43) Pub. Date: Jan. 19, 2006

(54) DC/DC converter

(75) Inventors: Shih-Chin Lin, Mailiao Township (TW); Hsiao-Yi Lin, Hsinchu City (TW); Wei Wang, Hualien City (TW)

Correspondence Address: LIU & LIU, 444 S. FLOWER STREET SUITE 1750, LOS ANGELES, CA, 90071, US

(73) Assignee: Toppoly Optoelectronics Corp.

(21) Appl. No.: 10/892,054

(22) Filed: Jul. 14, 2004

(51) Int. Cl. G05F 1/40

(52) U.S. Cl. 323/282

(57) ABSTRACT

A DC/DC converter. In the DC/DC converter, a DC/DC conversion circuit provides an output voltage to a storage capacitor upon receiving an enable signal. First and second resistors are connected in series to produce a first voltage according to the output voltage. A Schmitt trigger is coupled to the first voltage to output a first control signal through an inverter when the first voltage is smaller than a second voltage and to output a second control signal through the inverter when the first voltage is higher than a third voltage. An oscillator is turned off upon receiving the first control signal such that the DC/DC conversion circuit stops providing the output voltage, and is turned on and outputs the enable signal upon receiving the second control signal such that the DC/DC conversion circuit provides the output voltage to the storage capacitor.

### BACKGROUND OF THE INVENTION

1. Field of the Invention

The present invention relates to DC/DC converter, and more particularly, relates to a DC/DC converter capable of reduced power consumption without requiring additional reference voltages.

2. Description of the Related Art

FIG. 1 shows a conventional DC/DC converter 10. In the converter 10, the oscillator 11 enables the DC/DC conversion circuit 12 to provide a negative voltage to charge the storage capacitor C according to an input signal Sin. The DC/DC conversion circuit 12 then charges the storage capacitor C to a predetermined voltage and maintains the predetermined voltage. In this case, however, the DC/DC conversion circuit 12 is turned on and continuously consumes power. FIG. 2 shows another conventional DC/DC converter 20. In the converter 20, the comparator 24 produces and outputs a driving signal to the oscillator 21 according to the voltage at node D, thereby controlling whether load is charged by the DC/DC conversion circuit 23. The converter 20, however, requires an additional reference voltage Vref.

### SUMMARY OF THE INVENTION

The present invention is directed to a DC/DC converter, which is capable of reduced power consumption without requiring additional reference voltages.

In one aspect of the present invention, the circuit includes a DC/DC conversion circuit enabled to output an output voltage and a switch responsive to the output voltage to enable or disenable the DC/DC conversion circuit. In one embodiment of the present invention, a DC/DC conversion circuit provides an output voltage to a storage capacitor upon receiving an enable signal. First and second resistors are connected in series to produce a first voltage according to the output voltage. The switch includes a Schmitt trigger coupled to the first voltage to output a first control signal through an inverter when the first voltage is smaller than a second voltage and outputs a second control signal through the inverter when the first voltage is higher than a third voltage, wherein the second voltage is smaller than the third voltage. The switch also includes an oscillator, which is turned off upon receiving the first control signal such that the DC/DC conversion circuit stops providing the output voltage, and is turned on and outputs the enable signal upon receiving the second control signal such that the DC/DC conversion circuit provides the output voltage to the storage capacitor.

In another embodiment, the circuit includes an amplifier coupled between the detection circuit and the control circuit to amplify the first voltage, and the switching circuit can be an oscillator.

### BRIEF DESCRIPTION OF THE DRAWINGS

The present invention can be more fully understood by the subsequent detailed description and examples with reference made to the accompanying drawings, wherein:

FIG. 1 shows a conventional DC/DC converter;

FIG. 2 shows another conventional DC/DC converter;

FIG. 3 shows a DC/DC converter according to one embodiment of the present invention;

FIG. 4 shows an output diagram of the DC/DC converter shown in FIG. 3;

FIG. 5 shows another embodiment of the DC/DC converter according to the present invention; and

FIG. 6 is a schematic diagram of an electronic device having a display system with a DC/DC converter of the present invention.

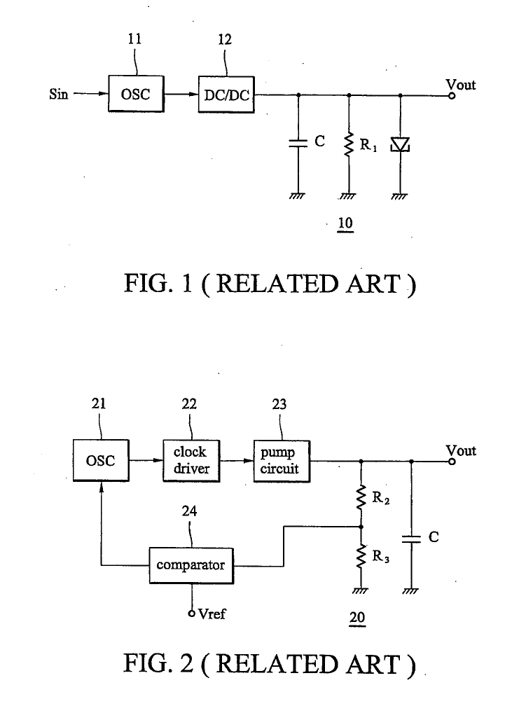

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

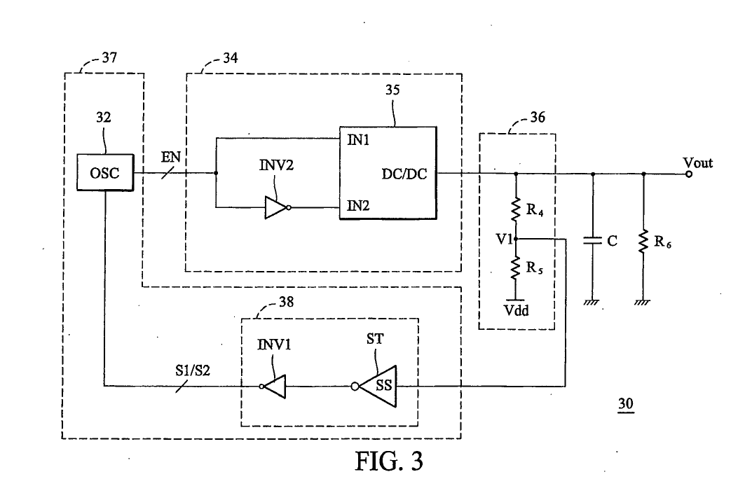

FIG. 3 shows a DC/DC converter 30 according to one embodiment of the present invention. As shown in FIG. 3, the converter 30 has a DC/DC conversion circuit 34, a detection circuit 36, and a switch 37 including a control circuit 38 and an oscillator 32.

The DC/DC conversion circuit 34 provides an output voltage Vout to a storage capacitor C upon receiving an enable signal EN, wherein resistor R6 can be a load. The detection circuit 36 produces a first voltage V1 according to the output voltage of the storage capacitor C. In this embodiment, the detection circuit 36 is voltage-divided circuit composed of the first and second resistors R4 and R5. The first resistor R4 has a first end coupled to the DC/DC conversion circuit 34, and a second end coupled to the second resistor R5, and the first voltage V1 is a divided voltage of the output voltage Vout.

The switch is coupled to the detection circuit and the DC/DC conversion circuit. The switch is responsive to the first voltage (i.e., the output voltage) to enable or disenable the DC/DC conversion circuit. In this embodiment, the control circuit 38 is coupled to the detection circuit 36 to receive the first voltage V1, and has a trigger, such as a Schmitt trigger ST, and an inverter INV1. The input of the Schmitt trigger ST is coupled to the first voltage V1 output from the detection circuit 36, and the input of the inverter INV1 is coupled to the output of the Schmitt trigger ST. Typically, a Schmitt trigger has a first trigger level and a second trigger level, for example the first trigger level is higher then the second trigger level. The Schmitt trigger outputs an output signal of a first logic level, such as LOW, when the input signal thereof is higher than the first trigger level. The Schmitt trigger continues to output the first logic level signal when the input signal decreases to the first trigger level. The Schmitt trigger outputs the second logic level signal until the input signal is reduced to smaller than the second trigger level, such as HIGH. Therefore, in the present invention, the control circuit 38 outputs a first control signal S1 to the oscillator 32 when the first voltage V1 is smaller than a second voltage V2, and outputs a second control signal S2 to the oscillator 32 when the first voltage is higher than a third voltage V3.

The oscillator 32 is coupled between the output of the inverter INV1 and the DC/DC conversion circuit 34. The oscillator 32 is turned off upon receiving the first control signal S1. The oscillator 32 does not output the enable signal. EN to the DC/DC conversion circuit 34, such that the DC/DC conversion circuit 34 stops providing output voltage Vout to the storage capacitor C and load R6. Additionally, the oscillator 32 is turned on upon receiving the second control signal S2. The oscillator 32 then outputs the enable signal EN to the DC/DC conversion circuit 34, such that the DC/DC conversion circuit 34 provides the output voltage Vout to the storage capacitor C1 and the load R6.

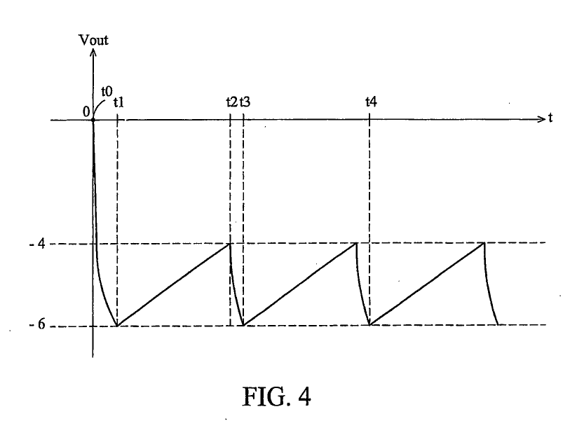

FIG. 4 is an example of an output wave diagram of the DC/DC converter 30. In this embodiment, the output voltage Vout provided by the DC/DC converter 30 is a negative voltage, the second voltage V2 can be 3.8V, and the third voltage V3 can be 4.4V.

At time t0, the output voltage is 0V, and the detection circuit 36 produces a first voltage V1 to output to Schmitt trigger ST. For example, in this case, the first voltage V1 is 5.6V when Vdd is 8V. At this time, the Schmitt trigger ST is triggered to output a low logic signal to the inverter INV1 as the first voltage V1 of 5.6V is higher than the third voltage V3 of 4.4V. The inverter INV1 then converts the low logic signal output from the Schmitt trigger ST to a high logic signal as the second control signal S2, and outputs to the oscillator 32. Consequently, the oscillator 32 is turned on and outputs an enable signal EN upon receiving the second control signal S2, such that the DC/DC conversion circuit 34 provides the output voltage Vout to the storage capacitor C and the load R6. In this case, the voltage of the storage capacitor C and the load R6 is increased to a negative value from 0V because the output voltage Vout is negative.

At time t1, the detection circuit 36 produces a first voltage V1 smaller than the second voltage (3.8V) to output to the Schmitt trigger ST when the output voltage Vout exceeds −6V. The Schmitt trigger ST is then triggered and outputs a high logic signal to inverter INV1. The inverter INV1 then converts the signal of high logic output from the Schmitt trigger ST to a low logic signal as the first control signal S1, and outputs to the oscillator 32. Consequently, the oscillator 32 is turned off upon receiving the first control signal S1, such that the DC/DC conversion circuit 34 stops providing the output voltage Vout to the storage capacitor C and the load R6. At this time, the voltage of the storage capacitor C and the load R6 starts to discharge.

At time t2, the detection circuit 36 produces a first voltage V1 higher than the third voltage (4.4V) to output to the Schmitt trigger ST when the output voltage Vout is higher than −4V. The Schmitt trigger St is then triggered again and outputs a low logic signal to inverter INV1. The inverter INV1 then converts the low logic signal output from the Schmitt trigger ST to a high logic signal as the second control signal S2, and outputs to the oscillator 32. Consequently, the oscillator 32 is turned on upon receiving the second control signal S2, such that the DC/DC conversion circuit 34 provides the output voltage Vout to the storage capacitor C1 and the load R6 again. At this time, the voltage of the storage capacitor C and the load R6 starts to discharge from −4V to −6V.

At time t4, the detection circuit 36 produces a first voltage V1 smaller than the second voltage (3.8V) to output to the Schmitt trigger ST again when the output voltage Vout exceeds −6V. The Schmitt trigger St is then triggered and outputs a high logic signal to the inverter INV1. The inverter INV1 then converts the signal of high logic output from the Schmitt trigger ST to a low logic signal as the first control signal S1, and outputs to the oscillator 32. Consequently, the oscillator 32 is turned off upon receiving the first control signal S1, such that the DC/DC conversion circuit 34 stops providing the output voltage Vout to the storage capacitor C and the load R6. At this time, the voltage of the storage capacitor C and the load R6 starts to discharge again. Therefore, the present invention can keep the output voltage within in a predetermined range, for example −4V-−6V.

In the DC/DC converter 30 of the present invention, the DC/DC conversion circuit 34 and the oscillator 32 can be controlled by the output voltage Vout from the storage capacitor C, and the load R6 and is not continuously turned on. Therefore, the present invention reduces energy consumption caused by the DC/DC conversion circuit 34 and the oscillator 32.

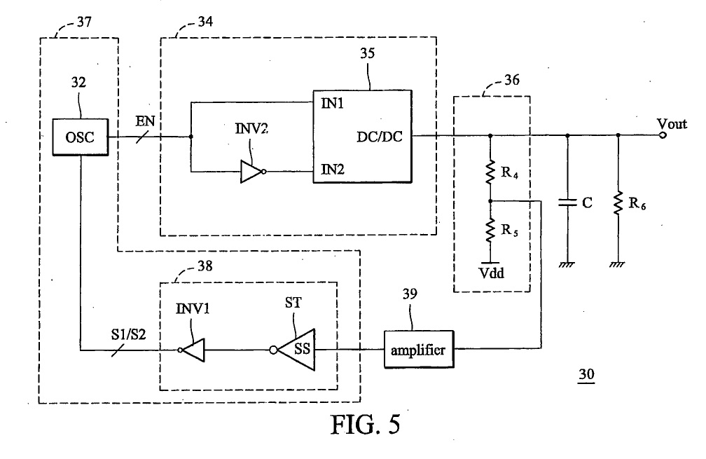

Additionally, as shown in FIG. 5, the DC/DC converter 30 further includes an amplifier coupled between the first and second resistors R4 and R5 and the Schmitt trigger ST to amplify the first voltage V1, such that the DC/DC converter does not malfunction because the voltage difference is too small.

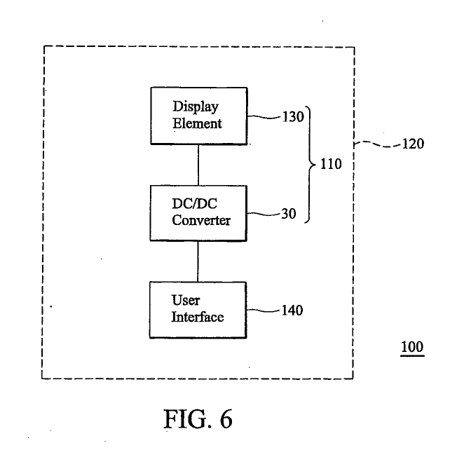

FIG. 6 schematically shows an electronic device 100 deploying a power consuming device such as a display system 110, and having a DC/DC converter 30 described above. The electronic device 100 may be a portable device such as a PDA, notebook computer, tablet computer, cellular phone, or a display monitor device, etc. Generally, then electronic device 100 includes a housing 120, the display system 110 having the DC/DC converter 30 and a display element 130, and a user interface 140, etc. Further, the DC/DC converter 30 in accordance with the present invention may be deployed to provide an output voltage to power the display element 130 and user interface 140, etc.

While the inventive DC/DC converter is described above in connection with an LCD display system, the present invention may be deployed in other types of display systems, such as systems deploying a plasma display element, or a cathode ray tube display element.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A DC/DC converter, comprising:
a DC/DC conversion circuit to provide an output voltage to a storage capacitor upon receiving an enable signal;
a detection circuit to produce a first voltage according to the output voltage of the storage capacitor;
a control circuit having a Schmitt trigger, coupled to the detection circuit to output a first control signal when the first voltage is lower than a second voltage and to output a second control signal when the first voltage is higher than a third voltage; and
a switching circuit turning off upon receiving the first control signal such that the DC/DC conversion circuit stops providing the output voltage, and turning on to output the enable signal upon receiving the second control signal such that the DC/DC conversion circuit provides the output voltage to the storage capacitor.

2. The DC/DC converter as claimed in claim 1, wherein the detection circuit is a voltage-divided circuit, comprising:
a first resistor having a first end coupled to the DC/DC conversion circuit; and
a second resistor having a first end coupled to a second end of the first resistor, as an output terminal coupled to an output of the Schmitt trigger.

3. The DC/DC converter as claimed in claim 1, wherein the control circuit further comprises an inverter having an input coupled to an output of the Schmitt trigger and an output coupled to the switching circuit.

4. The DC/DC converter as claimed in claim 1, wherein the second voltage is smaller than the third voltage.

5. The DC/DC converter as claimed in claim 1, further comprising an amplifier coupled between the detection circuit and the control circuit to amplify the first voltage.

6. The DC/DC converter as claimed in claim 1, wherein the switching circuit is an oscillator.

7. A display system, comprising a DC/DC converter as claimed in claim 1, and a display element coupled to the DC/DC converter, wherein the display element is powered by an output voltage from the DC/DC converter.

8. The display system as in claim 7, wherein the display element is at least one of liquid crystal display element, plasma display element and cathode ray tube element.

9. A circuit, comprising:
a DC/DC conversion circuit and a detection circuit coupled thereto;
the DC/DC conversion circuit enabled to output an output voltage upon receiving an enable signal;
the detection circuit producing a first voltage according to the output voltage; and
a switch, including a trigger, coupled to the DC/DC conversion circuit, the switch responsive to the first voltage to send the enable signal.

10. The circuit of claim 9, wherein the trigger is a Schmitt trigger.

11. The circuit of claim 9, wherein the trigger includes a triggering level, wherein the trigger sends a second control signal to enable the DC/DC conversion circuit when the first voltage is higher than the triggering level.

12. The circuit of claim 9, wherein the trigger includes a triggering level, wherein the trigger outputs a first control signal to enable the DC/DC conversion circuit when the first voltage is lower than the triggering level.

13. The circuit of claim 9, wherein the switch includes:
an oscillator, coupled between the trigger and the DC/DC conversion circuit, enabled to output the enable signal; and
the trigger, responsive to the first voltage, outputting a first control signal to enable the oscillator and a second control signal to disenable the oscillator.

14. The circuit of claim 9, further comprising an amplifier coupled between the detection circuit and the switch.

15. An electronic device, comprising:
a power consuming device; and
the circuit of claim 9, coupled to and supplying power to the power consuming device.

16. The electronic device as in claim 15, wherein the power consuming device comprises a display system.
